(19) United States
(12) Patent Application Publication
(10) Pub. No.: US 2020/0050212 A1
(43) Pub. Date: Feb. 13, 2020

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Yoshitaka Mimura, Wako-shi (JP); Masahiko Asakura, Wako-shi (JP); Naotaka Kumakiri, Wako-shi (JP); Kohei Okimoto, Wako-shi (JP); Hironori Takano, Wako-shi (JP)

(21) Appl. No.: 16/344,422

(22) PCT Filed: Nov. 4, 2016
(86) PCT No.: PCT/JP2016/082806

§ 371 Date: Apr. 24, 2019

(51) Int. Cl. G05D 1/02; B60W 30/095; B60W 40/02; B62D 15/02; G08G 1/14

(52) U.S. Cl. CPC G05D 1/0225; B60W 30/0956; G08G 1/14; B62D 15/0285; B60W 40/02

(57) ABSTRACT

A vehicle control system includes a receiver configured to receive an instruction from an occupant of a vehicle, and an automated driving controller configured to execute automated driving after the occupant of the vehicle exits the vehicle in a case in which an instruction to perform the automated driving after the occupant of the vehicle exits the vehicle is received by the receiver. Therefore, it is possible to improve the convenience of the occupant of the vehicle.

### TECHNICAL FIELD

The present invention relates to a vehicle control system, a vehicle control method, and a vehicle control program.

### BACKGROUND ART

In recent years, research on a technique for controlling a subject vehicle to automatically travel along a route to a destination has progressed. In relation to this, a driving support system that acquires information on a parking position of a vehicle desired by a user in a parking lot, monitors whether or not the desired parking position is vacant in a case in which a vehicle is parked at a parking position other than the desired parking position, and moves the vehicle to the desired parking position by automated driving and parks the vehicle in a case in which it is determined that the desired parking position is vacant by the monitoring is known (for example, refer to Patent Literature 1).

### CITATION LIST

### Patent Literature

Patent Literature 1

Japanese Unexamined Patent Application, First Publication No. 2015-153145

### SUMMARY OF INVENTION

### Technical Problem

However, the related art merely relates to automated driving after parking a vehicle in a parking lot, and situations other than this are not considered. Therefore, convenience of an occupant of the vehicle may be low.

The present invention has been made in consideration of such circumstances, and an object of the present invention is to provide a vehicle control system, a vehicle control method, and a vehicle control program capable of improving convenience of an occupant of a vehicle.

### Solution to Problem

According to the invention of claim 1, a vehicle control system (1) includes a receiver (30) configured to receive an instruction from an occupant of a vehicle, and an automated driving controller (100, 150) configured to execute automated driving after the occupant of the vehicle gets off the vehicle in a case in which an instruction to perform the automated driving after the occupant of the vehicle exits the vehicle is received by the receiver.

According to the invention of claim 2, the vehicle control system of claim 1 further includes a traffic situation acquirer (152) configured to acquire a traffic situation in a progress direction of a subject vehicle. In a case in which the automated driving controller determines that traffic congestion is occurring at a progress destination of the subject vehicle on the basis of information acquired by the acquirer, the automated driving controller executes automated driving to follow a preceding vehicle arranged in a row forming the traffic congestion.

According to the invention of claim 3, the vehicle control system of claim 2 further includes a communicator (20) configured to communicate with a terminal device used by the occupant of the vehicle, and a notification controller (158) configured to transmit predetermined information to the terminal device using the communicator before passing through the traffic congestion determined to be occurring by the automated driving controller.

According to the invention of claim 4, in the vehicle control system of claim 1, the automated driving controller executes the automated driving after the occupant exits the vehicle, on the basis of the instruction related to a continuation time of the automated driving after the occupant exits the vehicle, which is received by the receiver.

According to the invention of claim 5, in the vehicle control system of claim 4, the automated driving controller determines a traveling range on the basis of the instruction related to a continuation time of the automated driving after the occupant exits the vehicle, which is received by the receiver.

According to the invention of claim 6, in the vehicle control system of any one of claims 1 to 5, the automated driving controller executes automated driving that cyclically travels around a position where the occupant of the vehicle exited the vehicle.

According to the invention of claim 7, in the vehicle control system of any one of claims 1 to 6, the automated driving controller generates a plan of the automated driving so that the energy consumption is low.

According to the invention of claim 8, in the vehicle control system of any one of claims 1 to 7, the automated driving controller executes automated parking in the automated driving after the occupant of the vehicle exits the vehicle.

According to the invention of claim 9, a vehicle control method causes an in-vehicle computer to receive an instruction from an occupant of a vehicle and execute automated driving after the occupant of the vehicle exits the vehicle if an instruction to perform the automated driving after the occupant of the vehicle exits the vehicle is received.

According to the invention of claim 10, a vehicle control program causes an in-vehicle computer to receive an instruction from an occupant of a vehicle, and execute automated driving after the occupant of the vehicle exits the vehicle if an instruction to perform the automated driving after the occupant of the vehicle exits the vehicle is received.

### Advantageous Effects of Invention

According to the invention of claims 1, 4, 5, 7, 8, 9, and 10, the automated driving controller executes the automated driving after the occupant of the vehicle exits the vehicle in a case in which the instruction to perform the automated driving after the occupant of the vehicle exits the vehicle is received by the receiver. Therefore, it is possible to improve the convenience of the occupant of the vehicle.

According to the invention of claim 2, in a case in which the vehicle system 1 determines that the traffic congestion is occurring at the progress destination of the subject vehicle, the vehicle system 1 executes automated driving for arranging the subject vehicle in a row forming the traffic congestion. Therefore, it is not necessary for the occupant of the vehicle to wait in the vehicle.

According to the invention of claim 3, for example, if parking is performed in a parking lot where it is necessary to enter by manual driving, since the notification controller transmits the predetermined information to the terminal device used by the occupant of the vehicle before passing through the traffic congestion, the occupant of the vehicle is able to recognize that the subject vehicle is arriving near an entrance of the parking lot. As a result, the occupant of the vehicle is able to perform manual driving near the entrance of the parking lot and park the subject vehicle in the parking lot.

According to the invention of claim 6, the automated driving controller executes the automated driving that cyclically travels around the position where the occupant of the vehicle exits the vehicle. Therefore, even though there is no available parking, the occupant of the vehicle is able to exit the vehicle and complete a task.

### BRIEF DESCRIPTION OF DRAWINGS

FIG. 1 is a constitution diagram of a vehicle system 1 including an automated driving controller 100.

FIG. 2 is a diagram showing an aspect in which a subject vehicle position recognizer 122 recognizes a relative position and a posture of a subject vehicle M with respect to a traveling lane L1.

FIG. 3 is a diagram illustrating an aspect in which a target trajectory is generated on the basis of a recommended lane.

FIG. 4 is a flowchart (flowchart 1) showing a flow of a process executed by the automated driving controller 100.

FIG. 5 is a diagram showing an example of a situation in which the process of the flowchart of FIG. 4 is performed.

FIG. 6 is a flowchart (flowchart 2) showing a flow of a process executed by the vehicle system 1.

FIG. 7 is a diagram showing an example of a situation in which the process of the flowchart of FIG. 6 is performed.

FIG. 8 is a functional constitution diagram of a parking lot management system including a parking lot management device 300.

FIG. 9 is a flowchart showing a flow of a process executed by the parking lot management system.

FIG. 10 is a flowchart (flowchart 3) showing the flow of the process executed by the vehicle system 1.

FIG. 11 is a diagram showing an example of an image displayed on a displayer of an HMI 30.

FIG. 12 is a diagram showing an example of a situation in which the process of the flowchart of FIG. 10 is performed.

FIG. 13 is a flowchart (flowchart 4) showing the flow of the process executed by the vehicle system 1.

FIG. 14 is a flowchart showing the flow of the process executed by the parking lot management system.

FIG. 15 is a diagram showing an example of information stored in a management side storage 306 of the parking lot management device 300 of a modified example.

### DESCRIPTION OF EMBODIMENTS

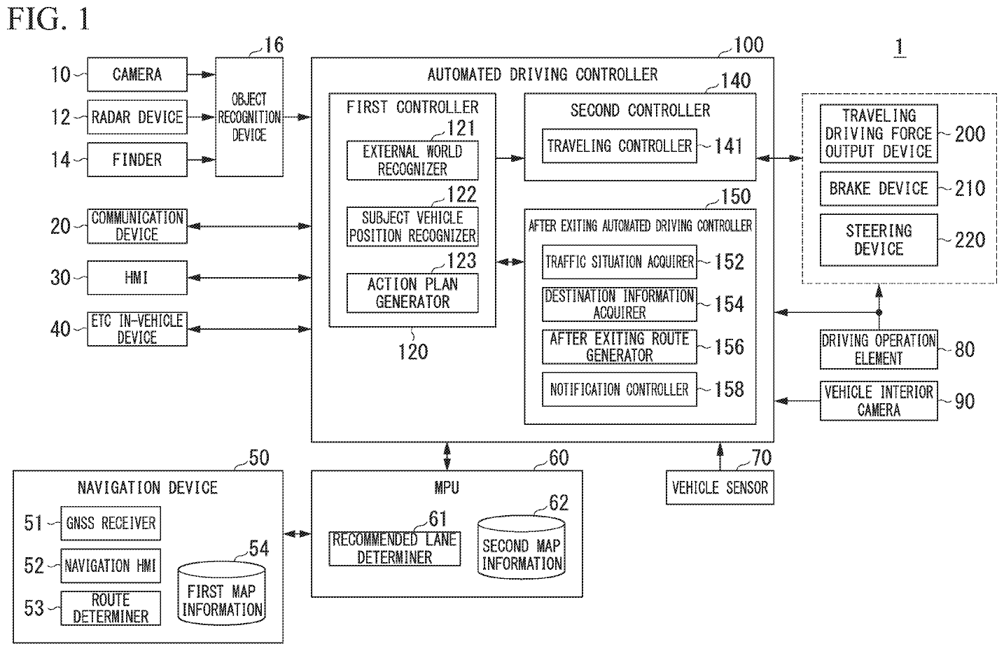

Hereinafter, embodiments of a vehicle control system, a vehicle control method, and a vehicle control program of the present invention will be described with reference to the drawings. FIG. 1 is a constitution diagram of a vehicle system 1 including an automated driving controller 100. A vehicle in which the vehicle system 1 is mounted is, for example, a vehicle such as a two-wheeled vehicle, a three-wheeled vehicle, or a four-wheeled vehicle, and a driving source of the vehicle is an internal combustion engine such as a diesel engine or a gasoline engine, an electric motor, or a combination thereof. The electric motor operates using electric power generated by a generator connected to the internal combustion engine or electric power discharged by a secondary battery or a fuel cell.

For example, the vehicle system 1 includes a camera 10, a radar device 12, a finder 14, an object recognition device 16, a communication device 20, a human machine interface (HMI) 30, an electronic toll collection system (ETC) in-vehicle device 40, a navigation device 50, a micro-processing unit (MPU) 60, a vehicle sensor 70, a driving operation element 80, a vehicle interior camera 90, the automated driving controller 100, a traveling driving force output device 200, a brake device 210, and a steering device 220. Such devices and instruments are connected to each other by a multiple communication line such as a controller area network (CAN) communication line, a serial communication line, a wireless communication network, or the like. Note that, the constitution shown in FIG. 1 is merely an example, and part of the constitution may be omitted or another constitution may be further added.

For example, the camera 10 is a digital camera using a solid imaging element such as a charge coupled device (CCD) or a complementary metal oxide semiconductor (CMOS). One or a plurality of cameras 10 are attached to arbitrary places on the vehicle (hereinafter, referred to as a subject vehicle M) in which the vehicle system 1 is mounted. In a case of forward imaging, the camera 10 is attached to an upper portion of a front windshield, a rear surface of a rearview mirror, or the like. For example, the camera 10 periodically repeats imaging of the surroundings of the subject vehicle M. The camera 10 may be a stereo camera.

The radar device 12 radiates radio waves such as millimeter waves or the like to the surroundings of the subject vehicle M and detects at least the position (distance and direction) of an object by detecting radio waves (reflected waves) reflected by the object. One or a plurality of radar devices 12 are attached to arbitrary places on the subject vehicle M. The radar device 12 may detect the position and the speed of the object by a frequency modulated continuous wave (FM-CW) method.

The finder 14 is light detection and ranging or laser imaging detection and ranging (LIDAR) which measures scattered light with respect to the irradiation light and detects the distance to the object. One or a plurality of finders 14 are attached to arbitrary places on the subject vehicle M.

The object recognition device 16 performs a sensor fusion process on a detection result by part or all of the camera 10, the radar device 12, and the finder 14 to recognize a position, a type, a speed, and the like of the object. The object recognition device 16 outputs a recognition result to the automated driving controller 100.

For example, the communication device 20 communicates with another vehicle that is present around the subject vehicle M using a cellular network, a Wi-Fi network, Bluetooth (registered trademark), dedicated short range communication (DSRC), or the like, or communicates with various server devices through a wireless base station.

The HMI 30 presents various types of information to an occupant of the subject vehicle M and receives an input operation by the occupant. The HMI 30 includes various display devices, speakers, buzzers, touch panels, switches, keys, and the like. Hereinafter, the HMI30 is described as a touch panel in which the displayer and the inputter are integrally formed.

The ETC in-vehicle device 40 includes a mount portion in which an ETC card is mounted, and a wireless communicator that communicates with an ETC roadside device provided at a gate of a toll road. The wireless communicator may be shared with the communication device 20. The ETC in-vehicle device 40 exchanges information of an entrance toll booth, an exit toll booth, or the like by communicating with the ETC roadside device. The ETC roadside device determines a charge amount for the occupant of the subject vehicle M on the basis of the information and proceeds a billing process.

For example, the navigation device 50 includes a global navigation satellite system (GNSS) receiver 51, a navigation HMI 52, and a route determiner 53, and holds first map information 54 in a storage device such as a hard disk drive (HDD) or a flash memory. The GNSS receiver specifies the position of the subject vehicle M on the basis of a signal received from a GNSS satellite. The position of the subject vehicle M may be specified or supplemented by an inertial navigation system (INS) using an output of the vehicle sensor 70. The navigation HMI 52 includes a display device, a speaker, a touch panel, a key, and the like. Part or all of the navigation HMI 52 may be shared with the HMI 30 described above. For example, the route determiner 53 determines a route from the position of the subject vehicle M specified by the GNSS receiver 51 (or an input arbitrary position) to a destination input by the occupant using the navigation HMI 52 by referring to the first map information 54. For example, the first map information 54 is information in which a road shape is expressed by a link indicating a road and nodes connected by the link. The first map information 54 may include a curvature of the road, point of interest (POI) information, or the like. The route determined by the route determiner 53 is output to the MPU 60. In addition, the navigation device 50 may perform route guidance using the navigation HMI 52 on the basis of the route determined by the route determiner 53. Note that, for example, the navigation device 50 may be implemented by a function of a terminal device such as a smartphone or a tablet terminal possessed by the user. In addition, the navigation device 50 may transmit a current position and a destination to a navigation server through the communication device 20 and acquire the route returned from the navigation server. In addition, the communication device 20 acquires a congestion situation of a road, a congestion situation of a parking lot, or the like from the navigation server.

For example, the MPU 60 functions as a recommended lane determiner 61 and holds second map information 62 in the storage device such as an HDD or a flash memory. The recommended lane determiner 61 divides the route provided from the navigation device 50 into a plurality of blocks (for example, divides the route into intervals of 100 [m] in a vehicle traveling direction) and determines a target lane for each block by referring to the second map information 62. The recommended lane determiner 61 determines the number of a lane from the left that the vehicle travels in. In a case where a branching position, a merging position, or the like is present on the route, the recommended lane determiner 61 determines the recommended lane so that the subject vehicle M is able to travel on a reasonable travel route for progressing to a branch destination.

The second map information 62 is map information with accuracy higher than that of the first map information 54. For example, the second map information 62 may include information on the center of a lane, information on a boundary of a lane, or the like. In addition, the second map information 62 may include road information, traffic regulation information, address information (an address and a postal code), facility information, telephone number information, and the like. The road information includes information indicating a type of a road such as an expressway, a toll road, a national road, and a prefectural road, information on the number of lanes of the road, widths of each lane, a slope of a road, a position of a road (three-dimensional coordinates including longitude, latitude, height), a curvature of a curve of a lane, positions of merging and branching points of lanes, a sign provided on a road, and the like. The second map information 62 may be updated at any time by accessing another device using the communication device 20.

The vehicle sensor 70 includes a vehicle speed sensor that detects a speed of the subject vehicle M, an acceleration sensor that detects acceleration, a yaw rate sensor that detects an angular velocity around a vertical axis, an orientation sensor that detects a direction of the subject vehicle M, and the like.

The driving operation element 80 includes, for example, an acceleration pedal, a brake pedal, a shift lever, a steering wheel, and other operation elements. A sensor that detects an operation amount or presence or absence of an operation is attached to the driving operation element 80, and a detection result of the sensor is output to at least one or both of the automated driving controller 100 or the traveling driving force output device 200, the brake device 210, and the steering device 220.

The vehicle interior camera 90 images an upper body centering on a face of the occupant seated in the driver's seat. The captured image of the vehicle interior camera 90 is output to the automated driving controller 100.

For example, the automated driving controller 100 includes a first controller 120, a second controller 140, and an after exiting automated driving controller 150. Each of the first controller 120, the second controller 140, and the after exiting automated driving controller 150 is implemented by a processor such as a central processing unit (CPU) executing a program (software). In addition, some or all of each functional unit may be implemented by hardware such as a large scale integration (LSI), an application specific integrated circuit (ASIC), or a field-programmable gate array (FPGA), or may be implemented by cooperation of software and hardware.

The first controller 120 includes, for example, an external world recognizer 121, a subject vehicle position recognizer 122, and an action plan generator 123.

The external world recognizer 121 recognizes states such as the position, the speed and the acceleration of the surrounding vehicle on the basis of information input from the camera 10, the radar device 12, and the finder 14 through the object recognition device 16. The position of the surrounding vehicle may be represented by the representative point such as the center of gravity or a corner of the surrounding vehicle, or may be represented by a region expressed by a contour of the surrounding vehicle. The “state” of the surrounding vehicle may include acceleration or a jerk of the surrounding vehicle, or an “action state” (for example, whether or not the surrounding vehicle is changing lanes or trying to change lanes). In addition, the external world recognizer 121 may also recognize positions of other objects such as a guardrail, a utility pole, a parked vehicle, or a pedestrian, in addition to the surrounding vehicle.

For example, the subject vehicle position recognizer 122 recognizes a lane (traveling lane) on which the subject vehicle M is traveling, and a relative position and a posture of the subject vehicle M with respect to the traveling lane. For example, the subject vehicle position recognizer 122 recognizes the traveling lane by comparing a pattern of a road lane marking (for example, an arrangement of a solid line and a broken line) obtained from the second map information 62 with a pattern of a road lane marking around the subject vehicle M recognized from the image captured by the camera 10. In this recognition, the position of the subject vehicle M acquired from the navigation device 50 or a process result by an INS may be added.

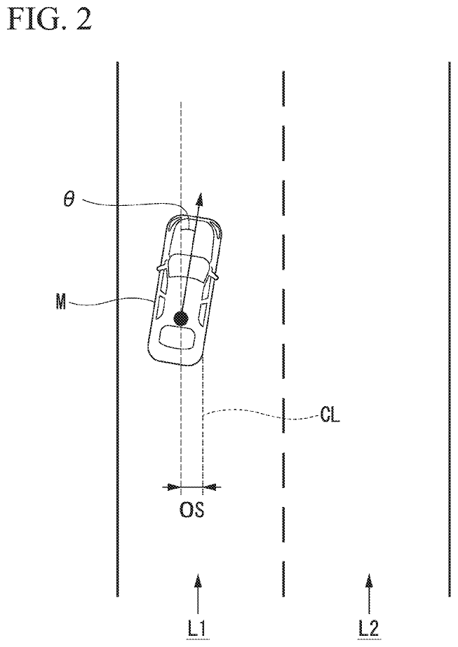

In addition, for example, the subject vehicle position recognizer 122 recognizes the position and a posture of the subject vehicle M with respect to the traveling lane. FIG. 2 is a diagram showing an aspect in which the subject vehicle position recognizer 122 recognizes the relative position and the posture of the subject vehicle M with respect to the traveling lane L1. For example, the subject vehicle position recognizer 122 recognizes a deviation OS of a reference point (for example, the center of gravity) of the subject vehicle M from a traveling lane center CL an angle θ formed by a line connecting the traveling lane center of a progress direction of the subject vehicle M as the relative position and the posture CL of the subject vehicle M with respect to the traveling lane L1. Note that, instead of this, the subject vehicle position recognizer 122 may recognize a position or the like of the reference point of the subject vehicle M with respect to one of side end portions of the subject lane L1 as the relative position of the subject vehicle M with respect to the traveling lane. The relative position of the subject vehicle M recognized by the subject vehicle position recognizer 122 is provided to the recommended lane determiner 61 and the action plan generator 123.

The action plan generator 123 determines the events to be sequentially executed in the automated driving so that the subject vehicle M travels on the recommended lane determined by the recommended lane determiner 61 and further copes with the surrounding situation of the subject vehicle M. The events include, for example, a constant-speed traveling event in which the subject vehicle M travels on the same traveling lane at a constant speed, a follow-up traveling event in which the subject vehicle M follows the preceding vehicle, a lane change event, a merge event, a branch event, an emergency stop event, and a handover event for switching driving to the manual driving by ending the automated driving. In addition, during the execution of these events, an action for avoidance may be planned on the basis of the surrounding situation (the presence of the surrounding vehicle or the pedestrian, lane constriction due to road construction, and the like) of the subject vehicle M.

The action plan generator 123 generates a target trajectory in which the subject vehicle M travels in the future. The target trajectory includes, for example, a speed element. For example, the target trajectory is generated by setting a plurality of future reference times for each predetermined sampling time (for example, about 0.X [sec]), and is generated as a set of target points (trajectory points) to be reached at such reference times. Therefore, in a case in which a width of the trajectory point is wide, it indicates that a vehicle travels a section between the trajectory points at high speed.

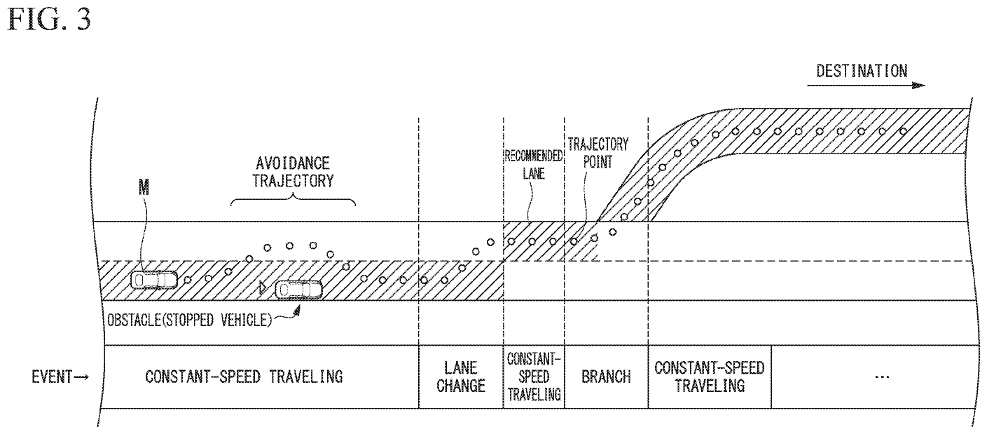

FIG. 3 is a diagram illustrating an aspect in which the target trajectory is generated on the basis of the recommended lane. As shown in the drawing, the recommended lane is set so that traveling along the route to the destination is convenient. The action plan generator 123 activates a lane change event, a branch event, a merge event, or the like when approaching a predetermined distance before a switching point of the recommended lane (which may be determined according to a kind of event). In a case where it is necessary to avoid an obstacle during the execution of each event, an avoidance trajectory is generated as shown in the drawing.

The action plan generator 123 generates, for example, a plurality of candidates of the target trajectory, and selects an optimal target trajectory at that time on the basis of a viewpoint of safety and efficiency.

The second controller 140 includes a traveling controller 141. The traveling controller 141 controls the traveling driving force output device 200, the brake device 210, and the steering device 220 so that the subject vehicle M passes through the target trajectory generated by the action plan generator 123 at a scheduled time.

The after exiting automated driving controller 150 includes a traffic situation acquirer 152, a destination information acquirer 154, an after exiting route generator 156, and a notification controller 158. The “vehicle control system” includes the HMI 30 (receiver) and the after exiting automated driving controller 150 (the traffic situation acquirer 152, the destination information acquirer 154, an after exiting route generator 156, and the notification controller 158).

The traffic situation acquirer 152 acquires a traffic situation in the progress direction of the subject vehicle M. The traffic situation is, for example, a congestion degree. For example, the traffic situation acquirer 152 analyzes the image captured by the camera 10 and derives traffic information to acquire the traffic situation. In addition, the traffic situation acquirer 152 may acquire the traffic situation from the navigation server through the communication device 20.

The destination information acquirer 154 acquires information on a destination of the subject vehicle M. The information on the destination is, for example, the congestion degree of the destination. For example, the destination information acquirer 154 analyzes the image captured by the camera 10 and derives information on the destination to acquire the information on the destination.

The after exiting route generator 156 determines a route through which the vehicle travels by the automated driving after the occupant of the vehicle exits the subject vehicle M, and generates the target trajectory on the basis of the route. The after exiting route generator 156 selects, for example, a target trajectory with higher safety in comparison with the action plan generator 123.

The notification controller 158 causes the HMI 30 to output predetermined information. In addition, the notification controller 158 may transmit the predetermined information to another terminal device through the communication device 20. Details of a process of the notification controller 158 will be described later. Details of a process of the above-described after exiting automated driving controller 150 will be described later.

The traveling driving force output device 200 outputs, to driving wheels, traveling driving force (torque) for enabling the vehicle to travel. For example, the traveling driving force output device 200 includes a combination of an internal combustion engine, an electric motor, a transmission, and the like, and an ECU that controls the internal combustion engine, the electric motor, the transmission, and the like. The ECU controls the above-described constitutions according to the information input from the traveling controller 141 or the information input from the driving operation element 80.

For example, the brake device 210 includes a brake caliper, a cylinder that transfers oil pressure to the brake caliper, an electric motor that generates the oil pressure in the cylinder, and a brake ECU. The brake ECU controls the electric motor according to the information input from the traveling controller 141 or the information input from the driving operation element 80, so that a brake torque according to a control operation is output to each wheel. The brake device 210 may include a mechanism for transferring the oil pressure generated by an operation of a brake pedal included in the driving operation element 80 to the cylinder through a master cylinder as a backup. Note that, the brake device 210 is not limited to the constitution described above, and may be an electronic control method oil pressure brake device that controls an actuator according to the information input from the traveling controller 141 to transfer the oil pressure of the master cylinder to the cylinder.

For example, the steering device 220 includes a steering ECU and an electric motor. For example, the electric motor changes a direction of steerable wheels by applying a force to a rack and pinion mechanism. The steering ECU changes the direction of the steerable wheels by driving the electric motor according to the information input from the traveling controller 141 or the information input from the driving operation element 80.

The vehicle system 1 of the present embodiment is able to improve the convenience of the occupant of the vehicle by executing the automated driving after the occupant of the vehicle exits in a case in which the instruction of the automated driving after exiting the vehicle is received from the occupant of the vehicle. More specifically, after the occupant of the vehicle exits the vehicle, the vehicle parks in a parking lot by the automated driving or is lined up in a row of the parking lot. Therefore, the occupant of the vehicle exiting the vehicle is able to effectively use time. Hereinafter, a process of the vehicle system 1 according to each situation is described.

[Parking to Parking Lot where Parking by Automated Driving is able to be Performed]

A process in a case in which the subject vehicle M is parked in the parking lot where the parking is able to be performed by the automated driving will be described. The parking lot where the parking is able to be performed by the automated driving is a parking lot where the operation by the occupant of the vehicle is not required when the vehicle enters the parking lot. For example, the parking lot where the parking is able to be performed by the automated driving is a parking lot where the occupant of the vehicle is not required to receive a parking ticket at the time of entrance.

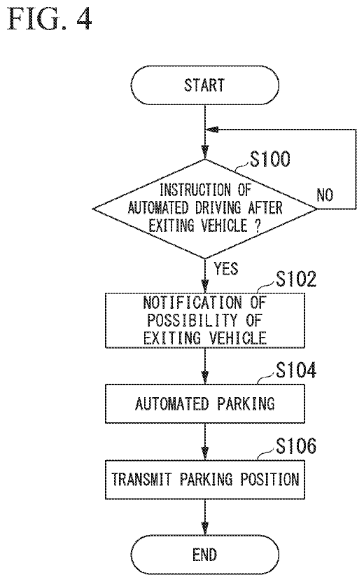

FIG. 4 is a flowchart (flowchart 1) showing a flow of the process executed by the automated driving controller 100. For example, the present process is a process in a case in which the parking lot where the parking is able to be performed by the automated driving is set as the destination of the vehicle and the automated driving is performed. A layout map including information on the parking lot where the parking is able to be performed by the automated driving and details of a parking position of the parking lot may be stored in the first map information 54 of the navigation device 50 or may be acquired from the navigation server.

First, the after exiting route generator 156 determines whether or not the occupant of the vehicle has given the instruction for the automated driving after exiting the vehicle (step S100). For example, the occupant of the vehicle gives the instruction of the automated driving after exiting the vehicle by performing a predetermined instruction on the touch panel, the switch, or the like of the HMI 30. At this time, the occupant of the vehicle may set a desired parking position in the parking lot.

In a case in which the instruction of the automated driving after exiting the vehicle is given by the occupant of the vehicle, the notification controller 158 causes the HMI 30 to output information indicating that it is possible to exit the vehicle (step S102). The output of this information causes the occupant of the vehicle to exit the vehicle. Hereinafter, it is assumed that the occupant of the vehicle has got off.

Next, the after exiting route generator 156 generates a target trajectory for parking the subject vehicle M at a predetermined parking position in the parking lot, which is the destination, and executes the automated driving to park the subject vehicle M to the predetermined parking position (step S104). For example, the automated driving controller 100 parks the subject vehicle M at the set desired parking position. In a case in which the desired parking position is not vacant, the automated driving controller 100 parks the subject vehicle M at a parking position close to the desired parking position among the vacant parking positions.

Note that, after the occupant of the vehicle exits the vehicle by the process of step S102, the subject vehicle may start the automated driving after a predetermined time has elapsed, or the occupant of the vehicle, who has got off the vehicle may give a predetermined instruction to cause the subject vehicle to M start the automated driving. The predetermined instruction is, for example, a predetermined action or gesture. In this case, the traffic situation acquirer 152 analyzes the image intermittently captured by the camera 10 and determines whether or not the occupant of the vehicle has performed an operation or the like associated with the predetermined instruction after exiting the vehicle. In a case in which it is determined that the occupant of the vehicle has performed the operation or the like associated with the predetermined instruction after exiting the vehicle, the traffic situation acquirer 152 outputs a determination result to the after exiting route generator 156. In a case in which the predetermined instruction is given, the after exiting route generator 156 starts traveling of the subject vehicle M for automated parking, and parks the subject vehicle M at the parking position.

Next, the notification controller 158 causes an occupant terminal device used by the occupant of the vehicle to transmit information indicating that the subject vehicle M is parked at the parking position (step S106). As a result, the occupant does not have to wait in the vehicle for a predetermined time to enter the parking lot due to traffic congestion or the like. Therefore, the process of the present flowchart is ended.

Note that, the occupant terminal device is, for example, a mobile phone such as a smartphone, a tablet terminal, a personal digital assistant (PDA), or the like. In addition, a communication address of the occupant terminal device is stored, for example, in a storage (not shown) included in the HMI 30. For example, the occupant of the vehicle operates the operator of the HMI 30 to store the communication address of the occupant terminal device in the storage.

Note that, the notification controller 158 may associate position information indicating the parking position of the subject vehicle M with the information indicating that the subject vehicle M is parked at the parking position, and transmit the position information to the occupant terminal device together with the information indicating that the subject vehicle M is parked at the parking position. Therefore, for example, since the parking position of the subject vehicle M is displayed on a displayer of the occupant terminal device, the occupant of the vehicle, who has got off the vehicle is able to recognize the parking position of the subject vehicle M.

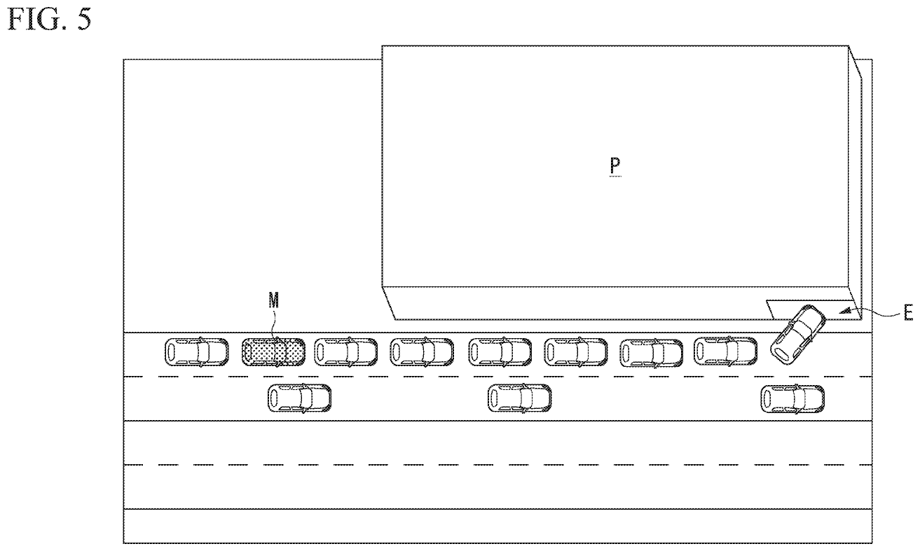

FIG. 5 is a diagram showing an example of a situation in which the process of the flowchart of FIG. 4 is performed. For example, it is assumed that a predetermined parking position in the parking lot P is set as the destination of the subject vehicle M. In the example shown in the figure, it is assumed that the traffic congestion is caused by a vehicle trying to enter the parking lot P. In such a situation, in a case in which the instruction of the automated driving after exiting the vehicle is given by the occupant of the vehicle, the subject vehicle M follows a vehicle in a progress direction in line with the traffic congestion in order to enter the parking lot P. In addition, in a case in which the subject vehicle M arrives at an entrance E of the parking lot P, the subject vehicle M travels into the parking lot P from the entrance E and parks at a predetermined position. As described above, in the vehicle system 1, in a case in which the instruction of the automated driving after exiting the vehicle is given by the occupant of the vehicle, the occupant of the vehicle does not have to wait in the vehicle for a predetermined time to enter the parking lot due to the traffic congestion or the like. Since the occupant of the vehicle is able to exit the vehicle and spend time on other things, the occupant of the vehicle is able to use time effectively.

Note that, in the example described above, when the subject vehicle M enters the parking lot, the ETC in-vehicle device 40 of the subject vehicle M may communicate with a communication device provided in the parking lot. The communication device provided in the parking lot communicates with a management device that manages the parking lot, and transmits a communication result to the management device. The management device may manage entry and exit of the vehicle and charge the occupant of the vehicle for the use fee of the parking lot by communicating with the ETC in-vehicle device and the communication device provided in the parking lot.

In addition, the traffic situation acquirer 152 may also acquire information indicating the congestion of the parking lot from the navigation server through the communication device 20. In addition, when the instruction of the automated driving after exiting the vehicle is given by the occupant of the vehicle, in a case in which the parking lot of the destination is congested, the notification controller 158 may cause the displayer of the HMI 30 to display the information indicating that the parking lot is congested and may cause the displayer of the HMI 30 to display information for prompting a change of a target parking lot, information of a parking lot that is not congested, or the like.

[Parking to Parking Lot where Parking is not able to be Performed by Automated Driving]

Instead of the process shown in the flowchart of FIG. 4, the following process may be performed. The process of the flowchart of FIG. 4 is a process for a parking lot where the automated parking is possible (or easy), and the process shown below is a process for a parking lot where the automated parking is not possible (or difficult). In the subject vehicle M, a program (function) that executes any one flowchart may be implemented, a program (function) may be automatically selected on the basis of whether or not the automated parking is possible, or the occupant may perform an operation of selecting a program (function) on the basis of whether or not the automated parking is possible.

A process in a case in which the subject vehicle M is parked in the parking lot where the parking is not able to be performed by the automated driving will be described. The parking lot where the parking is not able to be performed by the automated driving is a parking lot where an operation by the occupant of the vehicle is required when the vehicle enters the parking lot, a parking lot where a structure of the parking lot is not suitable for executing the automated driving, or the like. For example, the parking lot where the parking is not able to be performed by the automated driving is a parking lot where the occupant of the vehicle is required to receive a parking ticket at the time of entrance.

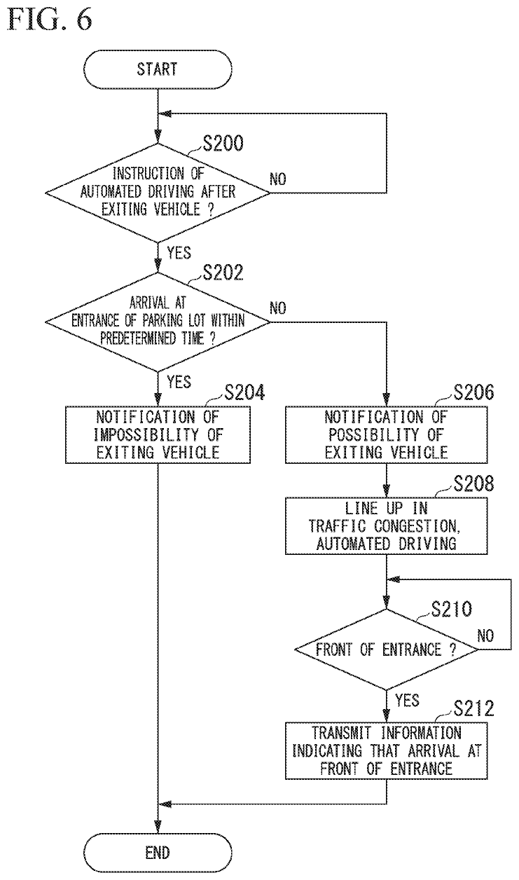

FIG. 6 is a flowchart (flowchart 2) showing a flow of the process executed by the vehicle system 1. For example, the present process is a process in a case in which the parking lot where the parking is not able to be performed by the automated driving is set as the destination of the vehicle and the automated driving is performed. In addition, in the present process, it is assumed that traffic congestion occurs at the destination of the subject vehicle M. First, the after exiting route generator 156 determines whether or not the occupant of the vehicle has given the instruction of the automated driving after exiting the vehicle (step S200).

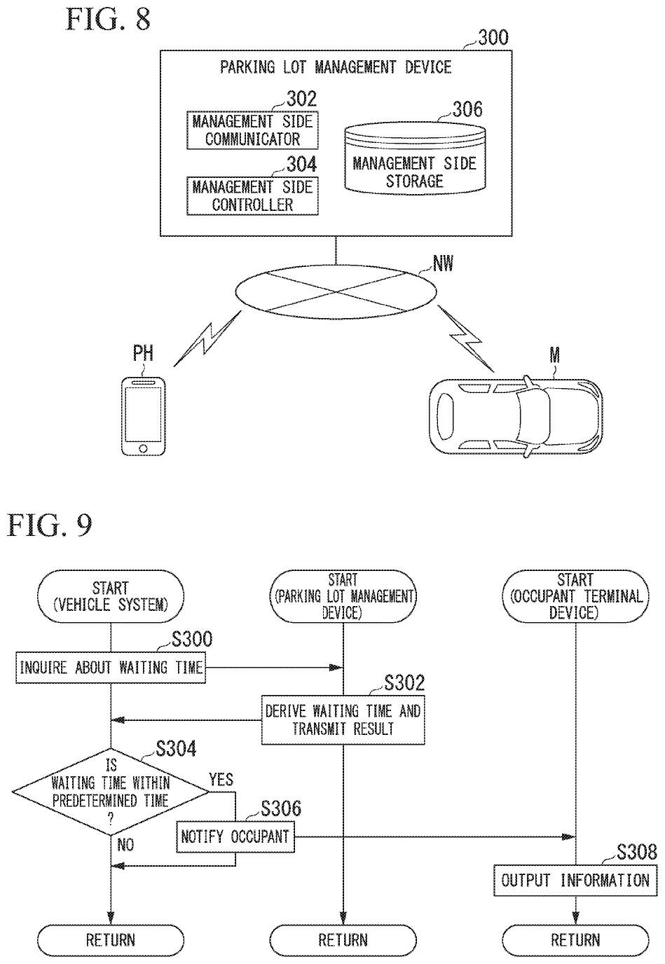

In a case in which the occupant of the vehicle has given the instruction of the automated driving after exiting the vehicle, the notification controller 158 determines whether or not the subject vehicle M will arrive at the entrance of the parking lot within a predetermined time (step S202). For example, the notification controller 158 acquires, from the navigation device 50, the time required for the subject vehicle M to arrive at the parking lot, to which the congestion degree is added. In addition, the traffic situation acquirer 152 may acquire the time required for the subject vehicle M to arrive at the parking lot, to which the congestion degree is added on the basis of the image captured by the camera 10. Note that another method of acquiring the time required for the subject vehicle M to arrive at the parking lot will be described later with reference to FIGS. 8 and 9.

In a case in which the subject vehicle M will arrive at the entrance of the parking lot within the predetermined time, the notification controller 158 causes the HMI 30 to output information indicating that the occupant of the vehicle is not able to exit the vehicle (step S204). Here, the predetermined time is, for example, about several minutes. In this case, this is because it would be necessary for the occupant of the vehicle to immediately get on the subject vehicle M in order for the subject vehicle M to enter the parking lot even though the occupant of the vehicle exits the subject vehicle M.

In a case in which the subject vehicle M will not arrive at the entrance of the parking lot within the predetermined time, the notification controller 158 causes the HMI 30 to output information indicating that the occupant of the vehicle is able to exit (step S206). In addition, the notification controller 158 may cause the displayer of the HMI 30 to display the time until the subject vehicle M arrives at the entrance of the parking lot. Therefore, the occupant of the vehicle is able to recognize the time required to get on the vehicle after exiting the vehicle.

Next, the automated driving controller 100 executes the automated driving to line up the subject vehicle M in the traffic congestion (step S208). For example, the traffic situation acquirer 152 recognizes that the congestion occurs in the progress destination of the subject vehicle M, and the after exiting route generator 156 controls the subject vehicle M so that the subject vehicle M follows the preceding vehicle on the basis of a recognition result. Next, the notification controller 158 stands by until the subject vehicle M arrives at a front of the entrance of the parking lot (step S210). The front of the entrance of the parking lot (an example of “before passing through the traffic congestion”) is, for example, a position at a predetermined distance from the entrance.

In addition, “the front of the entrance of the parking lot” may be a position at which the subject vehicle M is assumed to be present at a predetermined time before the time when the subject vehicle M is supposed to arrive at the entrance, or may be a set time before the time when the subject vehicle M is supposed to arrive at the entrance of the parking lot. The set time is set by the occupant of the vehicle through the HMI 30.

In a case in which the subject vehicle M arrives at the front of the entrance of the parking lot, the notification controller 158 transmits information (an example of the “predetermined information”) indicating that the subject vehicle M has arrived at the front of the entrance of the parking lot to the occupant terminal device through the communication device 20 (step S212). As a result, the occupant is able to return to the subject vehicle M, perform a procedure and the like for the parking, and complete the parking by manual driving. Therefore, the process of the present flowchart is ended.

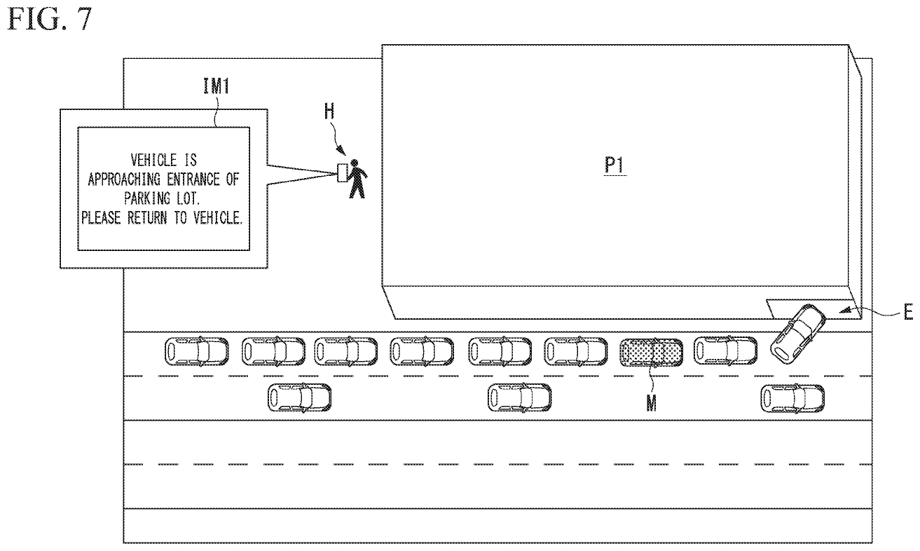

FIG. 7 is a diagram showing an example of a situation in which the process of the flowchart of FIG. 6 is performed. For example, it is assumed that the parking lot P1 is set as the destination of the subject vehicle M. The parking lot P1 is the parking lot where the parking is not able to be performed by the automated driving. As shown in the figure, it is assumed that the traffic congestion is caused by the vehicle trying to enter the parking lot P1. In such a situation, it is assumed that the instruction of the automated driving after exiting the vehicle is given by the occupant H of the vehicle, and the occupant H of the vehicle has got off the vehicle. In this case, the subject vehicle M follows the preceding vehicle in a row of the traffic congestion. In addition, in a case in which the subject vehicle M arrives at the front of the entrance of the parking lot P, the notification controller 158 transmits the information indicating that the subject vehicle M has arrived at the front of the entrance of the parking lot to the occupant terminal device through the communication device 20.

Therefore, an image IM1 including the information indicating that the subject vehicle M has arrived at the front of the entrance of the parking lot is displayed on the displayer of the occupant terminal device. In addition, the occupant H of the vehicle is able to recognize that it is necessary to get on the subject vehicle M and is able to get on the subject vehicle M and park the subject vehicle M in the parking lot. As a result, since the occupant H of the vehicle does not have to wait or the like in the vehicle while the subject vehicle M is in a row of the traffic congestion and is able to exit the vehicle and spend time on other things and the like, the occupant of the vehicle is able to use time effectively.

In a process of determining whether or not “the subject vehicle M arrives at the front of the entrance of the parking lot” of step S210 in FIG. 6, it may be determined whether or not “the waiting time until the subject vehicle M enters the parking lot is a predetermined time.” In addition, the waiting time until the subject vehicle M enters the parking lot is derived on the basis of the information received from the parking lot management device. Hereinafter, a parking lot management system that executes the process described above will be described.

FIG. 8 is a functional constitution diagram of the parking lot management system including a parking lot management device 300. The parking lot management system includes the subject vehicle M, an occupant terminal device PH, and the parking lot management device 300. The subject vehicle M, the occupant terminal device PH, and the parking lot management device 300 communicate with each other through the network NW. The network NW includes, for example, part or all of a wide area network (WAN), a local area network (LAN), a wireless base station, and the like.

The parking lot management device 300 includes a management side communicator 302, a management side controller 304, and a management side storage 306. The management side communicator 302 transmits a process result of the management side controller 304 to the occupant terminal device PH and the subject vehicle M. The management side controller 304 derives a waiting time until the subject vehicle M is able to use the parking lot on the basis of information stored in the management side storage 306. The management side storage 306 stores information indicating a use situation of the parking lot managed by the parking lot management device 300, identification information of a vehicle using the parking lot management system, a communication address, and the like. For example, the information indicating the use situation is information of entrance time and exit time of the vehicle which used the parking lot, a vacancy situation of the parking lot, or the like.

FIG. 9 is a flowchart showing a flow of a process executed by the parking lot management system. The present process is, for example, a process executed between step S208 and step S210 of FIG. 6. First, the automated driving controller 100 inquires of the parking lot management device 300 about the waiting time (step S300). In a case in which the management side controller 304 of the parking lot management device 300 receives the inquiry about the waiting time, the management side controller 304 derives the waiting time on the basis of the information stored in the management side storage 306, and transmits the derived waiting time to the vehicle system 1 (step S302).

For example, the management side controller 304 derives the waiting time by statistically processing a past use situation of the parking lot. More specifically, the management side controller 304 derives the waiting time on the basis of an average parking time of the vehicle to which the day of the week, the date and time, the weather, and the like are added. In this case, for example, the parking lot management device 300 acquires information on a distance from the entrance of the parking lot to the subject vehicle M or the traffic congestion in the progress direction of the subject vehicle M, and further adds the acquired information to derive the waiting time. The information on a distance from the entrance of the parking lot to the subject vehicle M or the traffic congestion in the progress direction of the subject vehicle M may be acquired from the subject vehicle M or may be acquired from another server device.

Note that the vehicle system 1 may have the same function as the management side controller 304. In this case, the vehicle system 1 acquires, from the parking lot management device 300, information indicating the use situation of the parking lot where the subject vehicle M is to be parked, which is stored in the management side storage 306.

Next, the notification controller 158 of the automated driving controller 100 determines whether or not the waiting time is within a predetermined time (step S304). In a case in which the waiting time is not within the predetermined time, the process of the present flowchart is ended. In a case in which the waiting time is within the predetermined time, the notification controller 158 notifies the occupant of the vehicle, who has exited the subject vehicle M, of information indicating that the waiting time is within the predetermined time through the communication device 20 (step S306). In addition, the occupant terminal device PH causes a displayer or the like to display (output) the information indicating that the waiting time is within the predetermined time (step S308). Therefore, the process of the present flowchart is ended.

Note that the process of acquiring the waiting time of the parking lot from the parking lot management device 300 may be used not only in the process of the flowchart of FIG. 6 but also in order to determine whether or not the occupant of the vehicle uses a target parking lot. In this case, the waiting time of the parking lot is acquired by the operation of the occupant of the vehicle for the HMI 30, and the acquired information is displayed on the displayer of the HMI 30.

[Process of Executing Automated Driving in State in which Occupant of Vehicle Exits Vehicle for Predetermined Time]

The process of executing the automated driving in a state in which the occupant of the vehicle exits the vehicle for a predetermined time will be described. For example, the present process is a process of causing the subject vehicle M to travel by the automated driving while the occupant of the vehicle finishes his or her business in a state in which the occupant of the vehicle exits the subject vehicle M, in a case in which it is impossible to park the subject vehicle M because a parking lot of a shopping center mall or the like is full.

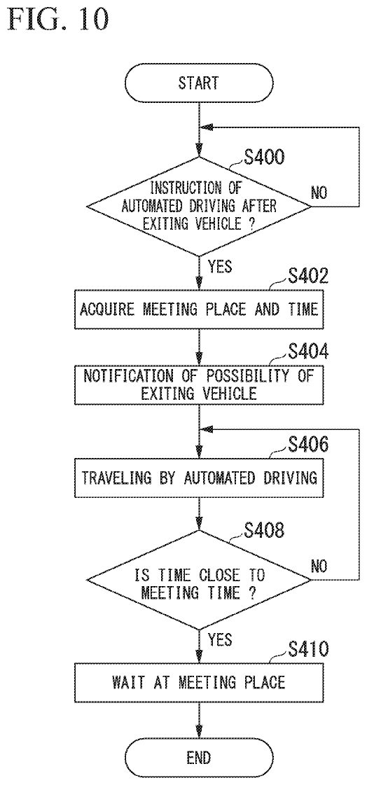

FIG. 10 is a flowchart (flowchart 3) showing the flow of the process executed by the vehicle system 1. First, the after exiting route generator 156 determines whether or not the occupant of the vehicle has given the instruction of the automated driving after exiting the vehicle (step S400). Next, the after exiting route generator 156 acquires a meeting place and a meeting time from the HMI 30 (step S402). The meeting place is a place (position) where the subject vehicle M executing the automated driving and the occupant of the vehicle meet after the occupant of the subject vehicle M exits the vehicle and the occupant of the subject vehicle M finishes his or her business. The meeting time is a time at which the subject vehicle M executing the automated driving arrives at the meeting place. The occupant of the vehicle operates the HMI 30 to input the meeting place and the meeting time.

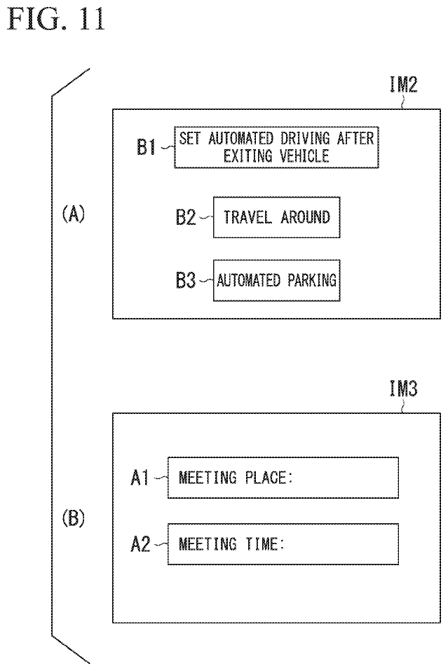

FIG. 11 is a diagram showing an example of an image displayed on the displayer of the HMI 30. For example, an image IM2 shown (A) in FIG. 9 and an image IM3 shown (B) in FIG. 9 are displayed on the displayer of the HMI 30. The image IM2 includes a reception button B1 for receiving the instruction of the automated driving after exiting the vehicle, a reception button B2 for receiving the instruction for executing the automated driving in a state in which the occupant of the vehicle exits the vehicle for a predetermined time, and a reception button B3 for receiving the instruction for performing the parking in the parking lot by the automated driving. In a case in which the occupant of the vehicle operates the reception button B2, a screen is switched from a screen on which the image IM2 is displayed to a screen on which the image IM3 is displayed. The image IM3 includes a setting area A1 for setting the meeting place, and a setting area A2 for setting the meeting time (an example of “a continuation time of the automated driving after exiting the vehicle”). The occupant of the vehicle sets the meeting place and the meeting time by performing a predetermined operation on the setting areas A1 and A2. The HMI 30 outputs the meeting place and the meeting time set by the occupant of the vehicle to the automated driving controller 100.

Next, the notification controller 158 causes the HMI 30 to output the information indicating that the occupant of the vehicle is able to exit the vehicle (step S404). In addition, it is assumed that the occupant of the vehicle has got off the vehicle after the present process. Next, the automated driving controller 100 executes the automated driving to cause the subject vehicle M to travel (step S406). A situation in which the process of step S406 is executed will be described using FIG. 10 which will be described later. Next, the notification controller 158 determines whether or not a time is close to the meeting time acquired in step S402 (step S408). In a case in which the time is not close to the meeting time, the process returns to step S406. In a case in which the time is close to the meeting time, the vehicle system 1 causes the subject vehicle M to travel toward the meeting place acquired in step S402 by the automated driving and wait at the meeting place at the meeting time (step S410). Therefore, the process of one routine of the present flowchart is ended.

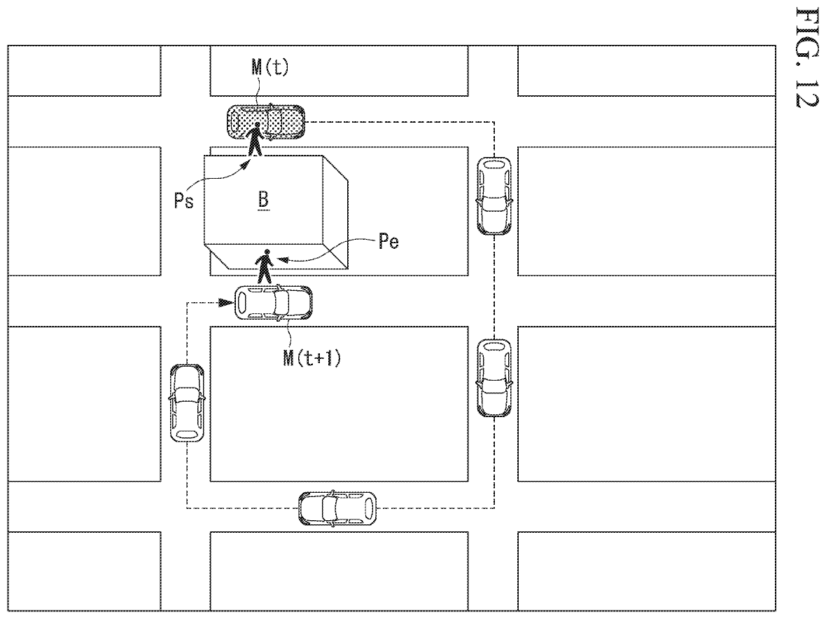

FIG. 12 is a diagram showing an example of a situation in which the process of the flowchart of FIG. 10 is performed. For example, it is assumed that a parking lot is not present in the vicinity of a building B where the occupant of the vehicle wants to finish his or her business. For example, it is assumed that the occupant of the vehicle performs the instruction of the automated driving after exiting the vehicle, sets a meeting place (Pe) and a meeting time (t+1) at a time t, and exits the subject vehicle M at a position Ps.

In this case, the subject vehicle M executes the automated driving to travel cyclically around the position Ps or the position Pe. In addition, the subject vehicle M waits at the meeting place at the meeting time. The occupant of the vehicle finishes his or her business in the building B, gets on the waiting vehicle M, and travels toward a next destination. As a result, even though a parking position is not present, the occupant of the vehicle is able to exit the subject vehicle M and finish his or her business by causing the subject vehicle to execute the automated driving for a predetermined time. As a result, the convenience of the occupant of the vehicle is improved.

An after exiting traveling route, which is a route along which the subject vehicle M travels until the meeting time after the occupant of the vehicle exits the vehicle, may be arbitrarily set. The after exiting traveling route is, for example, a route on which the vehicle will consume less energy. Specifically, the after exiting traveling route is a route assumed to have a high rate of the vehicle having to stop or travel slowly. In addition, the after exiting traveling route may be determined on the basis of the time for continuing the automated driving until the meeting time. For example, the route may be determined so that the subject vehicle M travels on a road included in a range of a distance farther from the position Ps or the position Pe when the time until the meeting time is longer.

Note that the after exiting route generator 156 may determine the after exiting traveling route on the basis of the route generated by the navigation device 50 or the navigation server. The navigation server acquires information on the road from a sensor provided on the road or a vehicle traveling on the road, and derives a congestion situation of the road and the like on the basis of the acquired information. For example, the navigation server derives a route that consumes less energy on the basis of the derived congestion situation of the road, the acquired information, and the like, and transmits the information on the derived route to the subject vehicle M.

In addition, the after exiting traveling route along which the subject vehicle M travels after the occupant of the vehicle exits the subject vehicle M until the meeting time may be a route through which the occupant of the vehicle passes the next destination. The destination is, for example, a store, a hospital, a parking lot where the subject vehicle M is to be parked next, or the like. In this case, the automated driving controller 100 causes the subject vehicle M to travel toward the next destination, and in a case in which the subject vehicle M arrives at the next destination, the destination information acquirer 154 causes the camera 10 to capture an image of the destination and the vicinity of the destination. The destination information acquirer 154 analyzes the image and transmits a situation of the destination (for example, the congestion degree) to the occupant terminal device through the communication device 20 or transmits the image captured by the camera 10 to the occupant terminal device. In addition, the destination information acquirer 154 may display the situation of the destination on the displayer of the HMI 30 when the occupant of the vehicle gets on the subject vehicle M. Therefore, the occupant of the vehicle is able to recognize the situation of the next destination.

In addition, after the occupant of the vehicle exits the subject vehicle M, during traveling on an after exiting traveling route on which the subject vehicle M travels until the meeting time, in a case in which the parking lot where the subject vehicle M is able to park is recognized (for example, in a case in which the parking position of the parking lot is vacant), the subject vehicle M automatically parks in the recognized parking lot. For example, the vehicle system 1 acquires the information related to the parking lot from the navigation server or the management device that manages the parking lot through the communication device 20 and recognizes the parking lot where the subject vehicle M is able to park on the basis of the acquired information. Note that the above-described after exiting traveling route and the execution of the automated parking in the traveling after exiting the vehicle may be set by the operation of the occupant of the vehicle for the HMI 30.

[Process for Executing Automated Driving in State in which Occupant of Vehicle Exits Vehicle until Instruction by Occupant is Given]

In the process described above, the subject vehicle M executes the automated driving during the time set by the occupant. On the other hand, in the present process, the subject vehicle M executes the automated driving in a state in which the occupant of the vehicle exits the vehicle until the instruction of the occupant is given.

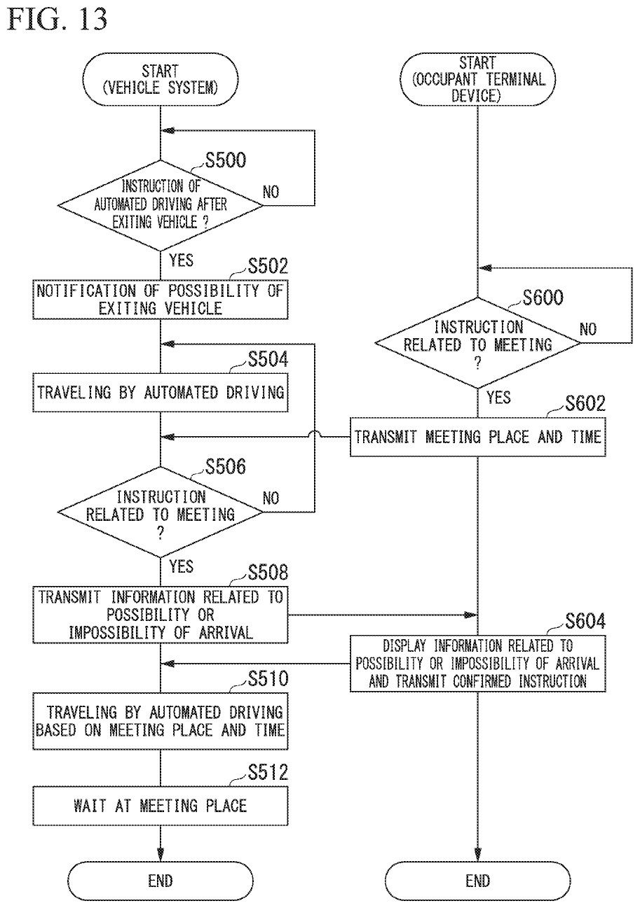

FIG. 13 is a flowchart (flowchart 4) showing the flow of the process executed by the vehicle system 1. First, the after exiting route generator 156 determines whether or not the instruction of the automated driving after exiting the vehicle is given by the occupant of the vehicle (step S500). Next, the notification controller 158 causes the HMI 30 to output the information indicating that the occupant of the vehicle is able to exit the vehicle (step S502). In addition, it is assumed that the occupant of the vehicle has got off the vehicle after the present process. Next, the vehicle system 1 executes the automated driving to cause the subject vehicle M to travel (step S504).

Next, the occupant terminal device PH waits until an instruction related to meeting is acquired (step S600). The instruction related to meeting is the meeting place and the meeting time. These pieces of information are set by an operation of the occupant of the vehicle on the touch panel of the occupant terminal device PH. Note that, one of the meeting place and the meeting time may be set by operating the HMI 30 before the occupant of the vehicle exits the subject vehicle M. Next, the occupant terminal device PH transmits the information on the set meeting to the vehicle system 1 (step S602).

Next, the vehicle system 1 waits until the instruction related to the meeting is received from the occupant terminal device PH (step S506). In a case in which the instruction related to the meeting is not received, the subject vehicle M executes the automated driving and cyclically travels around the position at which the occupant of the vehicle exits the vehicle. In a case in which the instruction related to the meeting is received, the vehicle system 1 transmits information related to possibility or impossibility of the arrival to the occupant terminal device PH on the basis of the received instruction related to the meeting (step S508). The information related to possibility or impossibility of the arrival is information indicating a possibility of arriving at the meeting place at the meeting time received from the occupant terminal device PH. For example, the traffic situation acquirer 152 of the vehicle system 1 causes the navigation device 50, another server device through the communication device 20, or the like to derive a route and a required time from a current location of the subject vehicle M to the meeting place, and acquires the derived information. In addition, on the basis of the derived information, the traffic situation acquirer 152 determines whether or not the subject vehicle is able to arrive at a location instructed at a time instructed by the occupant of the vehicle, and transmits a determination result to the occupant terminal device PH.

Next, the occupant terminal device PH receives the information related to the possibility or impossibility of the arrival from the vehicle system 1, causes the displayer to display the received information, and transmits information (confirmation instruction) indicating confirmation of the instruction to the vehicle system 1 in a case in which an operation of the instruction confirmation by the occupant of the vehicle is received (step S604). Note that, in a case in which the information displayed on the displayer is information indicating that the arrival at the meeting time is not possible, the occupant of the vehicle may instruct the meeting place or time again.

Next, in a case in which the confirmation instruction is received, the after exiting automated driving controller 150 causes the subject vehicle M to travel so that the subject vehicle M arrives at the instructed meeting place at the instructed meeting time (step S510), and waits at the meeting place at the meeting time (step S512). Therefore, the process of one routine of the present flowchart is ended. As described above, since the occupant of the vehicle is able to instruct the meeting place or the meeting time after exiting the subject vehicle M, a behavior of the occupant of the vehicle after exiting the vehicle is not restricted.

[Modified Example]

The management side controller 304 of the parking lot management device 300 of the modified example issues a numbered ticket to a vehicle scheduled to use the parking lot. In addition, the management side controller 304 permits the vehicle having the specified numbered ticket to use the parking lot.

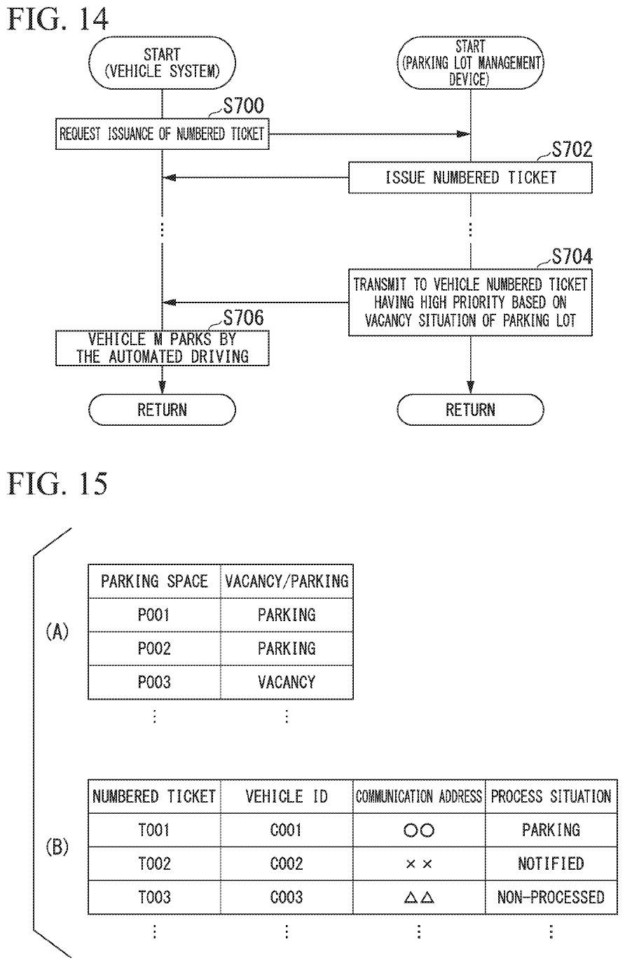

FIG. 14 is a flowchart showing the flow of the process executed by the parking lot management system. First, the traffic situation acquirer 152 requests the parking lot management device 300 to issue the numbered ticket through the communication device 20 (step S700). Next, the management side controller 304 of the parking lot management device 300 issues the numbered ticket to the vehicle that has requested the issuance of the numbered ticket (step S702). The numbered ticket is information defined by electronic information and is information indicating a priority of use of the parking lot. The issuance is transmission of information defined by electrical information. A condition under which the numbered ticket is issued may be arbitrarily determined such as being in the vicinity of the parking lot (within a predetermined distance from the parking lot), having entered the parking lot of a parking target, and the like.

Next, the management side controller 304 transmits information indicating that the vehicle is able to be parked in the parking lot to the vehicle having the numbered ticket having high priority on the basis of the vacancy of the parking lot (step S704).

FIG. 15 is a diagram showing an example of information stored in the management side storage 306 of the parking lot management device 300 of the modified example. FIG. 15(A) is a diagram showing an example of information indicating a vacant space of the parking lot. For example, in the information indicating the vacant space of the parking lot, information indicating whether or not a vehicle is parked is stored with respect to identification information of a parking space. FIG. 15(B) is a diagram showing an example of information related to the vehicle to which the numbered ticket is issued.

For example, with respect to an issue ID of the numbered ticket, identification information of the vehicle to which the numbered ticket is issued, a communication address of the vehicle, and information indicating a process situation for the numbered ticket are associated with the information related to the vehicle to which the numbered ticket is issued and are stored. The information indicating the process situation for the numbered ticket is information indicating whether or not the vehicle to which the numbered ticket is issued is parked, information indicating whether or not parking is notified because the parking lot is vacant, or information indicating that only the parking ticket is issued to the vehicle and other processes are not performed. For example, in a case in which there is a vacancy in the parking lot, the management side controller 304 notifies the vehicle, with which information indicating that the numbered ticket is issued but the numbered ticket is not processed is associated, of information indicating that the vehicle is able to park in the parking lot. In a case in which the automated driving controller 100 receives the information indicating that the vehicle is able to park, the automated driving controller 100 causes the subject vehicle M to park at a predetermined parking position in the parking lot by the automated driving (step S706). Therefore, the process of the present flowchart is ended.

Note that, in the process described above, the automated driving controller 100 may move the parking position by performing the automated driving again after stopping the subject vehicle M at the parking lot by the automated driving. The parking position of a movement destination may be a position set by the occupant of the vehicle in advance, or may be a position near an exit of a building in a site from the parking lot. As described above, the vehicle system 1 moves the parking position to the exit of the building in the site, or the like. Therefore, the convenience of the occupant of the vehicle is improved. For example, in the shopping center, in a case in which the occupant of the vehicle comes out from an exit after having finished shopping, it is convenient in a case in which the subject vehicle M is parked near the exit because a movement distance is short.

According to the embodiment described above, in a case in which the instruction for performing the automated driving after the occupant of the vehicle exits the vehicle is received by the HMI 30, the vehicle system 1 executes the automated driving after the occupant of the vehicle exits the vehicle, and thus it is possible to improve the convenience of the occupants of the vehicle.

As described above, although the embodiments for carrying out the present invention is described using the embodiment, the present invention is not limited at all by such an embodiment, and various modification and substitution within the range which does not deviate from the gist of the present invention can be added.

### REFERENCE SIGNS LIST

1—vehicle system, 100—automated driving controller, 120—first controller, 121—external world recognizer, 122—subject vehicle position recognizer, 123—action plan generator, 140—second controller, 141—traveling controller, 150—after exiting automated driving controller, 152—traffic situation acquirer, 154—destination information acquirer, 156—after exiting route generator, 158—notification controller

What is claim is:

1.-10. (canceled)

11. A vehicle control system comprising:
a receiver configured to receive an instruction from an occupant of a vehicle; and
an automated driving controller configured to execute automated driving after the occupant of the vehicle exits the vehicle in a case in which an instruction to perform the automated driving after the occupant of the vehicle exits the vehicle is received by the receiver.

12. The vehicle control system of claim 11, further comprising:
a traffic situation acquirer configured to acquire a traffic situation in a progress direction of a subject vehicle,
wherein, in a case in which the automated driving controller determines that traffic congestion is occurring at a progress destination of the subject vehicle on the basis of information acquired by the traffic situation acquirer, the automated driving controller executes automated driving to follow a preceding vehicle arranged in a row forming the traffic congestion.

13. The vehicle control system of claim 12, further comprising:
a communicator configured to communicate with a terminal device used by the occupant of the vehicle; and
a notification controller configured to transmit predetermined information to the terminal device using the communicator before passing through the traffic congestion determined to be occurring by the automated driving controller.

14. The vehicle control system of claim 11, wherein the automated driving controller executes the automated driving after exiting the vehicle, on the basis of the instruction related to a continuation time of the automated driving after exiting the vehicle, which is received by the receiver.

15. The vehicle control system of claim 14, wherein the automated driving controller determines a traveling range on the basis of the instruction related to a continuation time of the automated driving after exiting the vehicle, which is received by the receiver.

16. The vehicle control system of claim 15, wherein the automated driving controller executes automated driving of cyclically traveling around a position where the occupant of the vehicle exits the vehicle.

17. The vehicle control system of claim 16, wherein the automated driving controller generates a plan of the automated driving after the occupant of the vehicle exits the vehicle so that energy consumption is reduced.

18. The vehicle control system of claim 17, wherein the automated driving controller executes automated parking in the automated driving after the occupant of the vehicle exits the vehicle.

19. The vehicle control system of claim 11, wherein the automated driving controller executes automated driving of cyclically traveling around a position where the occupant of the vehicle exits the vehicle.

20. The vehicle control system of claim 11, wherein the automated driving controller generates a plan of the automated driving after the occupant of the vehicle exits the vehicle so that energy consumption is reduced.

21. The vehicle control system of claim 11, wherein the automated driving controller executes automated parking in the automated driving after the occupant of the vehicle exits the vehicle.

22. A vehicle control method using a vehicle control device, the vehicle control method comprising:
receiving an instruction from an occupant of a vehicle; and
executing automated driving after the occupant of the vehicle exits the vehicle in a case in which an instruction to perform the automated driving after the occupant of the vehicle exits the vehicle is received.

23. A non-transitory computer-readable storage medium that stores a computer program to be executed by a computer to perform at least:
receive an instruction from an occupant of a vehicle; and
execute automated driving after the occupant of the vehicle exits the vehicle in a case in which an instruction to perform the automated driving after the occupant of the vehicle exits the vehicle is received.
